(19) United States
(12) Patent Application Publication
(10) Pub. No.: US 2020/0252650 A1
(43) Pub. Date: Aug. 6, 2020

(54) VIDEO PROCESSING METHOD FOR BLOCKING IN-LOOP FILTERING FROM BEING APPLIED TO AT LEAST ONE BOUNDARY IN RECONSTRUCTED FRAME AND ASSOCIATED VIDEO PROCESSING APPARATUS

(71) Applicant: MEDIATEK INC., Hsin-chu (TW)

(72) Inventors: Cheng-Hsuan Shih, Hsinchu City (TW); Shen-Kai Chang, Hsin-Chu (TW); Jian-Liang Lin, Hsinchu City (TW); Hung-Chih Lin, Hsin-Chu (TW)

(21) Appl. No.: 16/856,069

(22) Filed: Apr. 23, 2020

Related U.S. Application Data
(62) Division of application No. 15/860,683, filed on Jan. 3, 2018.
(60) Provisional application No. 62/441,609, filed on Jan. 3, 2017.

(51) Int. Cl. H04N 19/597; H04N 19/46; H04N 19/82; H04N 19/513; H04N 19/593; H04N 19/105; H04N 19/167; H04N 19/59; H04N 19/117; H04N 19/176

(52) U.S. Cl. CPC H04N 19/597; H04N 19/46; H04N 19/82; H04N 19/513; H04N 19/593; H04N 19/107; H04N 19/167; H04N 19/59; H04N 19/117; H04N 19/176; H04N 19/105

(57) ABSTRACT

A video processing method includes: receiving a bitstream, wherein a part of the bitstream transmits encoded information of a projection-based frame that has a 360-degree content represented by projection faces packed in a 360-degree Virtual Reality (360 VR) projection layout, and the projection-based frame has at least one boundary; and decoding, by a video decoder, the part of the bitstream, including: generating a reconstructed frame, parsing a flag from the bitstream, and applying an in-loop filtering operation to the reconstructed frame. The flag indicates that the in-loop filtering operation is blocked from being applied to each of said at least one boundary in the reconstructed frame. In response to the flag, the in-loop filtering operation is blocked from being applied to each of the at least one boundary in the reconstructed frame.

### CROSS REFERENCE TO RELATED APPLICATION

This is a divisional application of U.S. application Ser. No. 15/860,683 filed on Jan. 3, 2018, which claims the benefit of U.S. provisional application No. 62/441,609 filed on Jan. 3, 2017. The entire contents of the related applications, including U.S. application Ser. No. 15/860,683 and U.S. provisional application No. 62/441,609, are incorporated herein by reference.

### BACKGROUND

The present invention relates to processing omnidirectional image/video content, and more particularly, to a video processing method for processing a projection-based frame with a 360-degree content (e.g., 360-degree image content or 360-degree video content) represented by projection faces packed in a 360-degree virtual reality (360 VR) projection layout.

Virtual reality (VR) with head-mounted displays (HMDs) is associated with a variety of applications. The ability to show wide field of view content to a user can be used to provide immersive visual experiences. A real-world environment has to be captured in all directions resulting in an omnidirectional image/video content corresponding to a viewing sphere. With advances in camera rigs and HMDs, the delivery of VR content may soon become the bottleneck due to the high bitrate required for representing such a 360-degree image/video content. When the resolution of the omnidirectional video is 4K or higher, data compression/encoding is critical to bitrate reduction.

In general, the omnidirectional video content corresponding to a sphere is transformed into a sequence of images, each of which is a projection-based frame with a 360-degree image/video content represented by projection faces arranged in a 360-degree Virtual Reality (360 VR) projection layout, and then the sequence of the projection-based frames is encoded into a bitstream for transmission. However, due to inherent characteristics of the employed 360 VR projection layout, it is possible that the projection-based frame has image content discontinuity boundaries that are introduced due to packing of the projection faces. In other words, discontinuous face edges are inevitable for most projection formats and packings. Hence, there is a need for one or more modified coding tools that are capable of minimizing the negative effect caused by the image content discontinuity boundaries (i.e., discontinuous face edges) resulting from packing of the projection faces.

### SUMMARY

One of the objectives of the claimed invention is to provide a video processing method and associated video processing apparatus for processing a projection-based frame with a 360-degree content (e.g., 360-degree image content or 360-degree video content) represented by projection faces packed in a 360-degree virtual reality (360 VR) projection layout. With a proper modification of the coding tool(s), the coding efficiency and/or the image quality of the reconstructed frame can be improved.

According to a first aspect of the present invention, an exemplary video processing method is disclosed. The exemplary video processing method comprises: receiving a bitstream, wherein a part of the bitstream transmits encoded information of a projection-based frame that has a 360-degree content represented by projection faces packed in a 360-degree Virtual Reality (360 VR) projection layout, and the projection-based frame has at least one boundary; and decoding, by a video decoder, the part of the bitstream, comprising: generating a reconstructed frame; parsing a flag from the bitstream, wherein the flag indicates that an in-loop filtering operation is blocked from being applied to each of said at least one boundary in the reconstructed frame; and applying the in-loop filtering operation to the reconstructed frame, wherein in response to the flag, the in-loop filtering operation is blocked from being applied to each of said at least one boundary in the reconstructed frame.

According to a second aspect of the present invention, an exemplary video processing apparatus is disclosed. The exemplary video processing apparatus comprises a video decoder. The video decoder includes a decoding circuit and a control circuit. The decoding circuit is arranged to receive a bitstream, parse a flag from the bitstream, decode a part of the bitstream to generate a reconstructed frame, and apply an in-loop filtering operation to the reconstructed frame, wherein the part of the bitstream transmits encoded information of a projection-based frame, the projection-based frame has a 360-degree content represented by projection faces packed in a 360-degree Virtual Reality (360 VR) projection layout, the projection-based frame has at least one boundary, and the flag indicates that the in-loop filtering operation is blocked from being applied to each of said at least one boundary in the reconstructed frame. The control circuit is arranged to control the in-loop filtering operation according to the flag, wherein in response to the flag, the in-loop filtering operation is blocked from being applied to each of said at least one boundary in the reconstructed frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a 360-degree Virtual Reality (360 VR) system according to an embodiment of the present invention.

FIG. 2 is a diagram illustrating a video encoder according to an embodiment of the present invention.

FIG. 3 is a diagram illustrating a video decoder according to an embodiment of the present invention.

FIG. 4 is a diagram illustrating six square projection faces of a cubemap projection (CMP) layout obtained from a cube projection of a sphere.

FIG. 5 is a diagram illustrating a compact projection layout with a 3×2 padding format according to an embodiment of the present invention.

FIG. 6 is a diagram illustrating a modified coding tool which treats a spatial neighbor as non-available according to an embodiment of the present invention.

FIG. 7 is a diagram illustrating a modified coding tool which finds a real neighbor for inter prediction according to an embodiment of the present invention.

FIG. 8 is a diagram illustrating a modified coding tool which finds a real neighbor for intra prediction according to an embodiment of the present invention.

FIG. 9 is a diagram illustrating a modified coding tool which finds a real neighbor for MPM list construction of intra prediction according to an embodiment of the present invention.

FIG. 10 is a diagram illustrating a modified coding tool which prevents in-loop filtering from being applied to discontinuous face edges in a reconstructed frame with a first projection layout according to an embodiment of the present invention.

FIG. 11 is a diagram illustrating a modified coding tool which applies in-loop filtering to continuous face edges in a reconstructed frame with a second projection layout according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

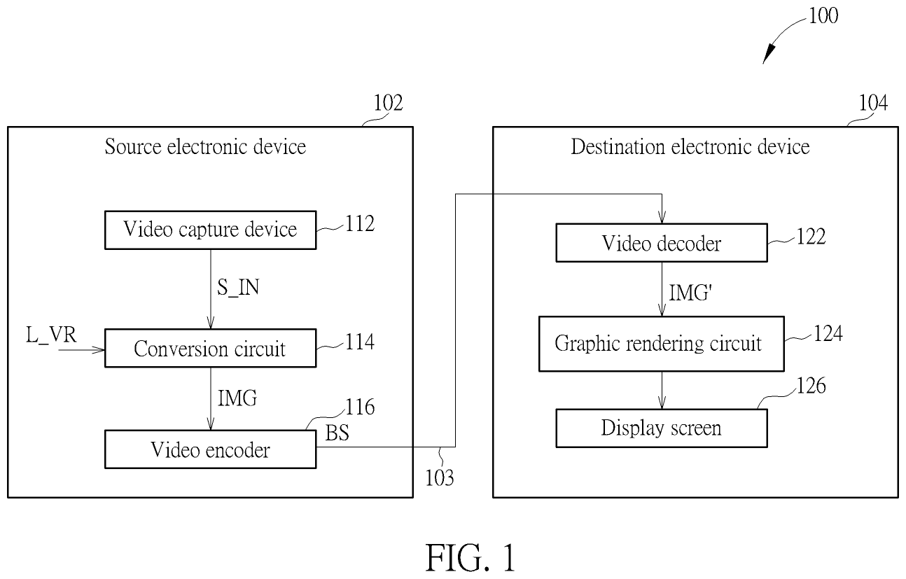

FIG. 1 is a diagram illustrating a 360-degree Virtual Reality (360 VR) system according to an embodiment of the present invention. The 360 VR system 100 includes two video processing apparatuses (e.g., a source electronic device 102 and a destination electronic device 104). The source electronic device 102 includes a video capture device 112, a conversion circuit 114, and a video encoder 116. For example, the video capture device 112 may be a set of cameras used to provide an omnidirectional image/video content (e.g., multiple images that cover the whole surroundings) S_IN corresponding to a sphere. The conversion circuit 114 is coupled between the video capture device 112 and the video encoder 116. The conversion circuit 114 generates a projection-based frame IMG with a 360-degree Virtual Reality (360 VR) projection layout L_VR according to the omnidirectional image/video content S_IN. For example, the projection-based frame IMG may be one frame included in a sequence of projection-based frames generated from the conversion circuit 114. The video encoder 116 is an encoding circuit used to encode/compress the projection-based frame IMG to generate a part of a bitstream BS, and outputs the bitstream BS to the destination electronic device 104 via a transmission means 103. For example, the sequence of projection-based frames may be encoded into the bitstream BS, such that a part of the bitstream BS transmits encoded information of the projection-based frame IMG. In addition, the transmission means 103 may be a wired/wireless communication link or a storage medium.

The destination electronic device 104 may be a head-mounted display (HMD) device. As shown in FIG. 1, the destination electronic device 104 includes a video decoder 122, a graphic rendering circuit 124, and a display screen 126. The video decoder 122 is a decoding circuit used to receive the bitstream BS from the transmission means 103 (e.g., a wired/wireless communication link or a storage medium), and decode the received bitstream BS. For example, the video decoder 122 generates a sequence of decoded frames by decoding the received bitstream BS, where the decoded frame IMG′ is one frame included in the sequence of decoded frames. That is, since apart of the bitstream BS transmits encoded information of the projection-based frame IMG, the video decoder 122 decodes the part of the received bitstream BS to generate a decoded frame IMG′ which is a decoding result of the encoded projection-based frame IMG. In this embodiment, the projection-based frame IMG to be encoded by the video encoder 116 has a 360 VR projection format with a projection layout. Hence, after the bitstream BS is decoded by the video decoder 122, the decoded frame IMG′ has the same 360 VR projection format and the same projection layout. The graphic rendering circuit 124 is coupled between the video decoder 122 and the display screen 126. The graphic rendering circuit 124 renders and displays an output image data on the display screen 126 according to the decoded frame IMG′. For example, a viewport area associated with a portion of the 360-degree image/video content carried by the decoded frame IMG′ may be displayed on the display screen 126 via the graphic rendering circuit 124.

The present invention proposes techniques at the coding tools to conquer the negative effect introduced by image content discontinuity boundaries (i.e., discontinuous face edges) resulting from packing of projection faces. In other words, the video encoder 116 can employ modified coding tool(s) for encoding the projection-based frame IMG, and the counterpart video decoder 122 can also employ modified coding tool(s) for generating the decoded frame IMG′.

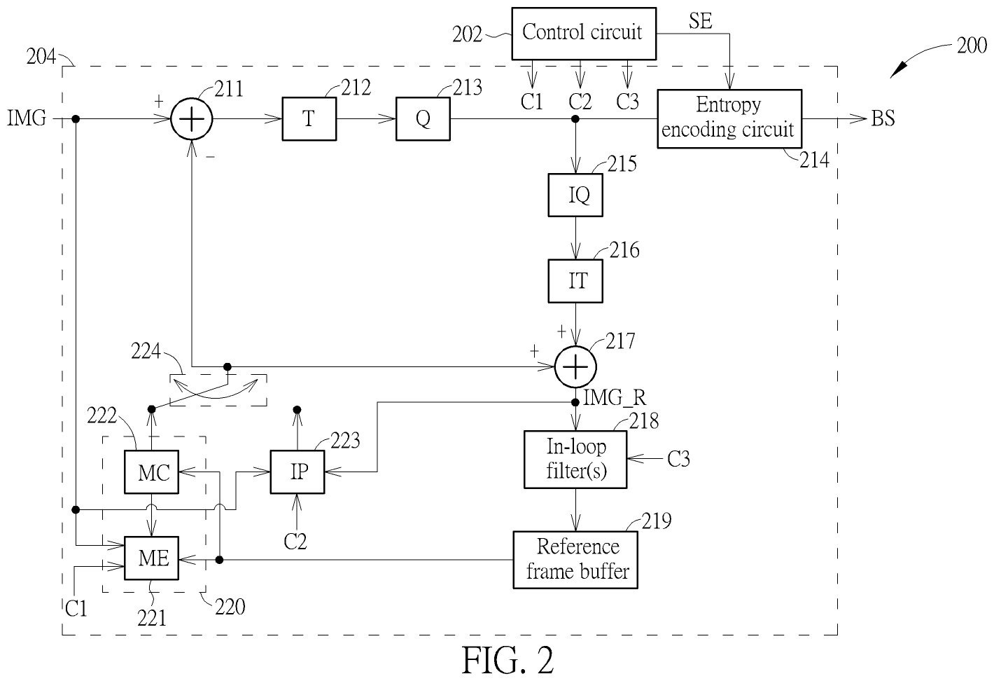

FIG. 2 is a diagram illustrating a video encoder according to an embodiment of the present invention. The video encoder 116 shown in FIG. 1 may be implemented using the video encoder 200 shown in FIG. 2. The video encoder 200 includes a control circuit 202 and an encoding circuit 204. It should be noted that the video encoder architecture shown in FIG. 2 is for illustrative purposes only, and is not meant to be a limitation of the present invention. For example, the architecture of the encoding circuit 204 may vary, depending upon the coding standard. The encoding circuit 204 encodes the projection-based frame IMG (which has the 360-degree image/video content represented by the projection faces arranged in the 360 VR projection layout L_VR) to generate a part of the bitstream BS. As shown in FIG. 2, the encoding circuit 204 includes a residual calculation circuit 211, a transform circuit (denoted by “T”) 212, a quantization circuit (denoted by “Q”) 213, an entropy encoding circuit (e.g., a variable length encoder) 214, an inverse quantization circuit (denoted by “IQ”) 215, an inverse transform circuit (denoted by “IT”) 216, a reconstruction circuit 217, at least one in-loop filter 218, a reference frame buffer 219, an inter prediction circuit 220 (which includes a motion estimation circuit (denoted by “ME”) 221 and a motion compensation circuit (denoted by “MC”) 222), an intra prediction circuit (denoted by “IP”) 223, and an intra/inter mode selection switch 224. The at least one in-loop filter 218 may include a de-blocking filter, a sample adaptive offset (SAO) filter, and/or an adaptive loop filter (ALF). Since basic functions and operations of these circuit components implemented in the encoding circuit 204 are well known to those skilled in the pertinent art, further description is omitted here for brevity.

It should be noted that a reconstructed frame IMG_R generated from the reconstruction circuit 217 is stored into the reference frame buffer 219 to serve as a reference frame after being processed by the in-loop filter 218. The reconstructed frame IMG_R may be regarded as a decoded version of the encoded projection-based frame IMG. Hence, the reconstructed frame IMG_R also has a 360-degree image content represented by projection faces arranged in the same 360 VR projection layout L_VR.

The major difference between the encoding circuit 204 and a typical encoding circuit is that the inter prediction circuit 220, the intra prediction circuit 223, and/or the in-loop filter 218 may be instructed by the control circuit 202 to enable the modified coding tool(s). For example, the control circuit 202 generates a control signal C1 to enable a modified coding tool at the inter prediction circuit 220, generates a control signal C2 to enable a modified coding tool at the intra prediction circuit 223, and/or generates a control signal C3 to enable a modified coding tool at the in-loop filter 218. In addition, the control circuit 202 may be further used to set one or more syntax elements (SEs) associated with the enabling/disabling of the modified coding tool(s), where the syntax element(s) are signaled to a video decoder via the bitstream BS generated from the entropy encoding circuit 214. For example, a flag of a modified coding tool can be signaled via the bitstream BS.

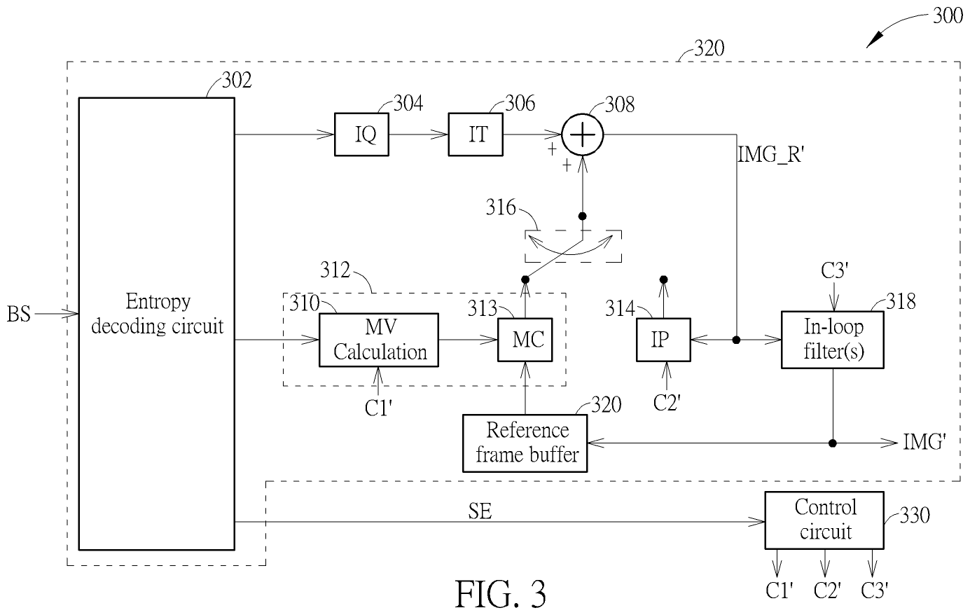

FIG. 3 is a diagram illustrating a video decoder according to an embodiment of the present invention. The video decoder 122 shown in FIG. 1 may be implemented using the video decoder 300 shown in FIG. 3. The video decoder 300 may communicate with a video encoder (e.g., video encoder 100 shown in FIG. 1 or video encoder 200 shown in FIG. 2) via a transmission means such as a wired/wireless communication link or a storage medium. In this embodiment, the video decoder 300 receives the bitstream BS, and decodes a part of the received bitstream BS to generate a decoded frame IMG′. As shown in FIG. 3, the video decoder 300 includes a decoding circuit 320 and a control circuit 330. It should be noted that the video decoder architecture shown in FIG. 3 is for illustrative purposes only, and is not meant to be a limitation of the present invention. For example, the architecture of the decoding circuit 320 may vary, depending upon the coding standard. The decoding circuit 320 includes an entropy decoding circuit (e.g., a variable length decoder) 302, an inverse quantization circuit (denoted by “IQ”) 304, an inverse transform circuit (denoted by “IT”) 306, a reconstruction circuit 308, an inter prediction circuit 312 (which includes a motion vector calculation circuit (denoted by “MV Calculation”) 310 and a motion compensation circuit (denoted by “MC”) 313), an intra prediction circuit (denoted by “IP”) 314, an intra/inter mode selection switch 316, at least one in-loop filter (e.g., de-blocking filter, SAO filter, and/or ALF) 318, and a reference frame buffer 320. In this embodiment, the projection-based frame IMG to be encoded by the video encoder 100 has a 360-degree image/video content represented by projection faces arranged in the 360 VR projection layout L_VR. Hence, after the bitstream BS is decoded by the video decoder 300, the decoded frame IMG′ also has a 360-degree image content represented by projection faces arranged in the same 360 VR projection layout L_VR. A reconstructed frame IMG_R′ generated from the reconstruction circuit 308 is stored into the reference frame buffer 320 to serve as a reference frame and also acts as the decoded frame IMG′ after being processed by the in-loop filter 318. Hence, the reconstructed frame IMG_R′ also has a 360-degree image content represented by projection faces arranged in the same 360 VR projection layout L_VR. Since basic functions and operations of these circuit components implemented in the decoding circuit 320 are well known to those skilled in the pertinent art, further description is omitted here for brevity.

The major difference between the decoding circuit 320 and a typical decoding circuit is that the inter prediction circuit 312, the intra prediction circuit 314, and/or the in-loop filter 318 may be instructed by the control circuit 330 to enable the modified coding tool(s). For example, the control circuit 330 generates a control signal C1′ to enable a modified coding tool at the inter prediction circuit 312, generates a control signal C2′ to enable a modified coding tool at the intra prediction circuit 314, and/or generates a control signal C3′ to enable a modified coding tool at the in-loop filter 318. In addition, the entropy decoding circuit 302 is further used to process the bitstream BS to obtain syntax element(s) associated with the enabling/disabling of the modified coding tool(s). Hence, the control circuit 330 of the video decoder 300 can refer to the parsed syntax element(s) to determine whether to enable the modified coding tool(s).

In the present invention, the 360 VR projection layout L_VR may be any available projection layout. For example, the 360 VR projection layout L_VR may be a cube-based projection layout or a triangle-based projection layout. For better understanding of technical features of the present invention, the following assumes that the 360 VR projection layout L_VR is set by a cube-based projection layout. In practice, the modified coding tools proposed by the present invention may be adopted to encode/decode 360 VR frames having projection faces packed in other projection layouts. These alternative designs also fall within the scope of the present invention.

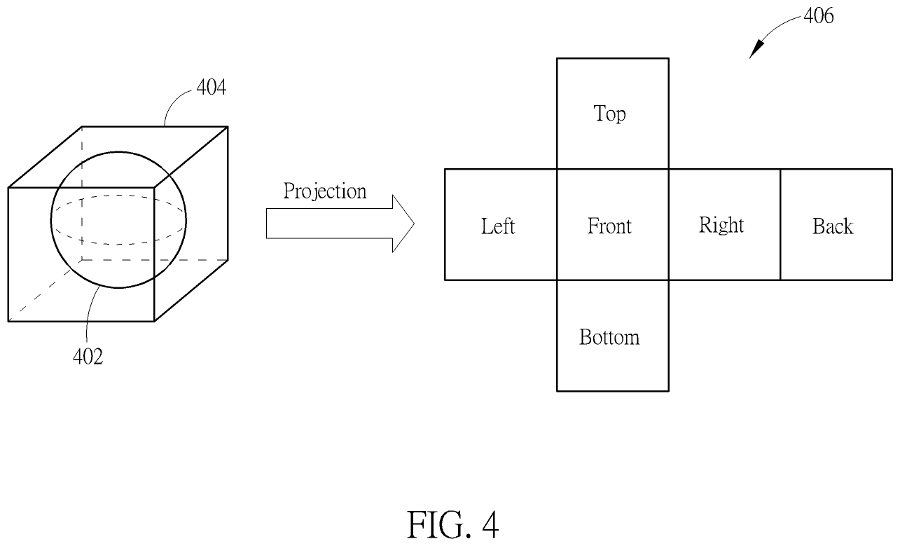

FIG. 4 is a diagram illustrating six square projection faces of a cubemap projection (CMP) layout obtained from a cube projection of a sphere. An omnidirectional image/video content of a sphere 402 is mapped/projected onto six square projection faces (labeled by “Left”, “Front”, “Right”, “Back”, “Top”, and “Bottom”) of a cube 404. As shown in FIG. 4, the square projection faces “Left”, “Front”, “Right”, “Back”, “Top”, and “Bottom” are arranged in a CMP layout 406 corresponding to an unfolded cube. The projection-based frame IMG to be encoded is required to be rectangular. If the CMP layout 406 is directly used for creating the projection-based frame IMG, the projection-based frame IMG may be filled with dummy areas (e.g., black areas or white areas) to form a rectangle frame for encoding. Hence, a compact projection layout may be used to eliminate or reduce dummy areas (e.g., black areas or white areas) for coding efficiency improvement.

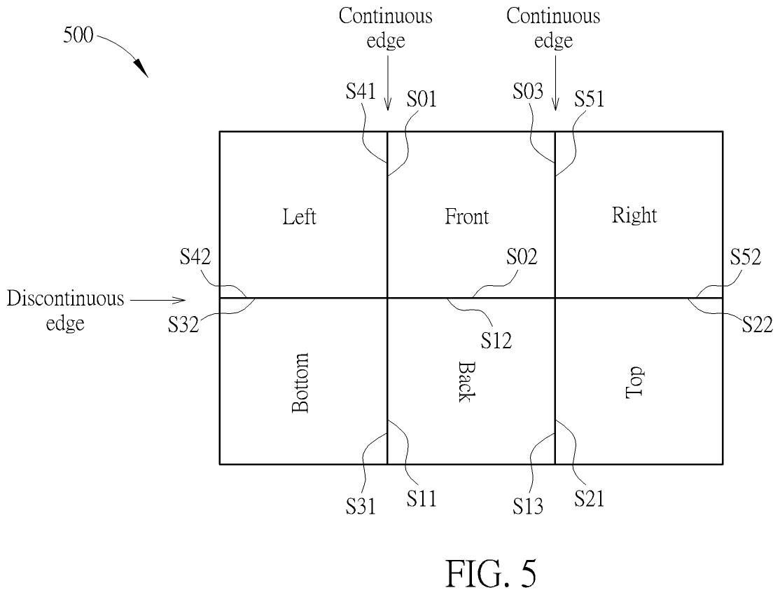

FIG. 5 is a diagram illustrating a compact projection layout with a 3×2 padding format according to an embodiment of the present invention. The compact projection layout 500 with the 3×2 padding format is derived by rearranging the square projection faces “Left”, “Front”, “Right”, “Back”, “Top”, and “Bottom” of the CMP layout 406. Regarding the compact projection layout 500 with the 3×2 padding format, the side S41 of the square projection face “Left” connects with the side S01 of the square projection face “Front”, the side S03 of the square projection face “Front” connects with the side S51 of the square projection face “Right”, the side S31 of the square projection face “Bottom” connects with the side S11 of the square projection face “Back”, the side S13 of the square projection face “Back” connects with the side S21 of the square projection face “Top”, the side S42 of the square projection face “Left” connects with the side S32 of the square projection face “Bottom”, the side S02 of the square projection face “Front” connects with the side S12 of the square projection face “Back”, and the side S52 of the square projection face “Right” connects with the side S22 of the square projection face “Top”.

Regarding the compact projection layout 500 with the 3×2 padding format, an image content continuity boundary (i.e., a continuous face edge) exists between the side S41 of the square projection face “Left” and the side S01 of the square projection face “Front”, an image content continuity boundary (i.e., a continuous face edge) exists between the side S03 of the square projection face “Front” and the side S51 of the square projection face “Right”, an image content continuity boundary (i.e., a continuous face edge) exists between the side S31 of the square projection face “Bottom” and the side S11 of the square projection face “Back”, and an image content continuity boundary (i.e., a continuous face edge) exists between the side S13 of the square projection face “Back” and the side S21 of the square projection face “Top”. In addition, an image content discontinuity boundary (i.e., a discontinuous face edge) exists between the side S42 of the square projection face “Left” and the side S32 of the square projection face “Bottom”, an image content discontinuity boundary (i.e., a discontinuous face edge) exists between the side S02 of the square projection face “Front” and the side S12 of the square projection face “Back”, and an image content discontinuity boundary (i.e., a discontinuous face edge) exists between the side S52 of the square projection face “Right” and the side S22 of the square projection face “Top”.

When the 360 VR projection layout L_VR is set by the compact projection layout 500 with the 3×2 padding format, the projection-based frame IMG has image content discontinuity boundaries resulting from packing of square projection faces “Left”, “Front”, Right”, “Bottom”, “Back”, and “Top”. To improve the coding efficiency and the image quality of the reconstructed frame, the present invention proposes several coding tool modifications for minimizing the negative effect caused by the image content discontinuity boundaries (i.e., discontinuous face edges). The following assumes that the projection-based frame IMG employs the aforementioned compact projection layout 500. Further details of the proposed coding tool modifications are described as below.

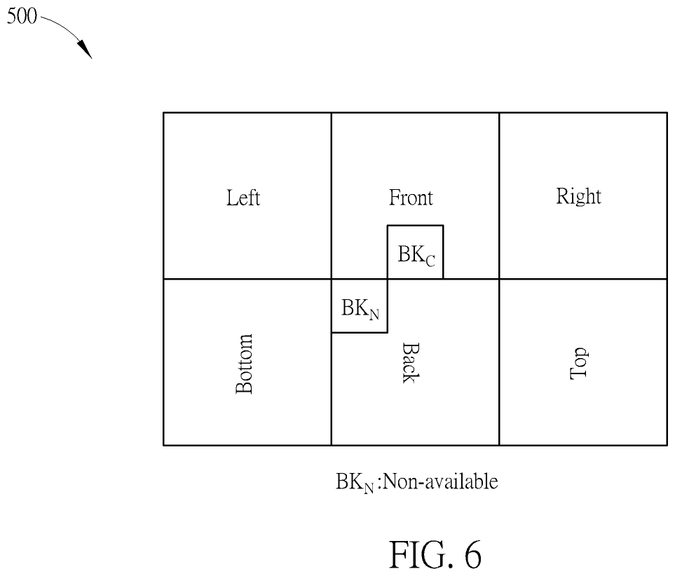

Please refer to FIG. 5 in conjunction with FIG. 6. FIG. 6 is a diagram illustrating a modified coding tool which treats a spatial neighbor as non-available according to an embodiment of the present invention. In some embodiments of the present invention, the modified coding tool of treating a spatial neighbor as non-available may be enabled at an encoder-side inter prediction stage. For example, the inter prediction circuit 220 of the video encoder 200 may employ the modified coding tool. Hence, the inter prediction circuit 220 (particularly, the motion estimation circuit 221) performs an inter prediction operation upon a current block BK_{C}. According to the modified coding tool, the inter prediction circuit 220 (particularly, the motion estimation circuit 221) checks if the current block BK_{C} and a spatial neighbor (e.g., BK_{N}) of the current block BK_{C} are located at different projection faces in the projection-based frame IMG and are on opposite sides of one image content discontinuity boundary in the projection-based frame IMG. When a checking result indicates that the current block BK_{C} and the spatial neighbor BK_{N} are located at different projection faces in the projection-based frame IMG and are on opposite sides of one image content discontinuity boundary in the projection-based frame IMG, the inter prediction circuit 220 (particularly, the motion estimation circuit 221) treats the spatial neighbor (e.g., BK_{N}) as non-available to the inter prediction operation of the current block BK_{C}.

As shown in FIG. 6, the current block BK_{C} is apart of the square projection face “Front”, the spatial neighbor BK_{N} is a part of the square projection face “Back”, and the current block BK_{C} and the spatial neighbor BK_{N} are on opposite sides of the image content discontinuity boundary between side S02 of the square projection face “Front” and side S12 of the square projection face “Back”. Hence, the spatial neighbor BK_{N} is regarded as a “null neighbor”, and the inter prediction circuit 220 (particularly, the motion estimation circuit 221) avoids using the wrong neighbor for inter prediction. For example, the current block BK_{C} is a prediction unit (PU), and the spatial neighbor BK_{N} (which is a block already reconstructed/encoded by the video encoder 200) is a spatial candidate included in a candidate list of an advanced motion vector prediction (AMVP) mode, a merge mode, or a skip mode, where the candidate list is constructed at the encoder side. Since the current block BK_{C} and the spatial neighbor BK_{N} are located at different projection faces in the projection-based frame IMG and are on opposite sides of one image content discontinuity boundary in the projection-based frame IMG, the motion information of the spatial neighbor BK_{N} is not misused by the inter prediction circuit 220 (particularly, the motion estimation circuit 221), thereby improving the coding efficiency.

In some embodiments of the present invention, the modified coding tool of treating a spatial neighbor as non-available may be enabled at an encoder-side intra prediction stage. For example, the intra prediction circuit 223 of the video encoder 200 may employ the modified coding tool. Hence, the intra prediction circuit 223 performs an intra prediction operation upon a current block BK_{C}. According to the modified coding tool, the intra prediction circuit 223 checks if the current block BK_{C} and a spatial neighbor (e.g., BK_{N}) of the current block BK_{C} are located at different projection faces in the projection-based frame IMG and are on opposite sides of one image content discontinuity boundary in the projection-based frame IMG. When a checking result indicates that the current block BK_{C} and the spatial neighbor (e.g., BK_{N}) are located at different projection faces in the projection-based frame IMG and are on opposite sides of one image content discontinuity boundary in the projection-based frame IMG, the intra prediction circuit 223 treats the spatial neighbor BK_{N} as non-available to the intra prediction operation of the current block BK_{C}.

As shown in FIG. 6, the current block BK_{C} is a part of the square projection face “Front”, the spatial neighbor BK_{N} is a part of the square projection face “Back”, and the current block BK_{C} and the spatial neighbor BK_{N} are on opposite sides of the image content discontinuity boundary between side S02 of the square projection face “Front” and side S12 of the square projection face “Back”. Hence, the spatial neighbor BK_{N} is regarded as a “null neighbor”, and the intra prediction circuit 223 avoids using the wrong neighbor for intra prediction. For example, the current block BK_{C} is a prediction unit (PU), and the spatial neighbor BK_{N} (which is a pixel already reconstructed/encoded by the video encoder 200) is a reference sample for an intra prediction mode (IPM). Since the current block BK_{C} and the spatial neighbor BK_{N} are located at different projection faces in the projection-based frame IMG and are on opposite sides of one image content discontinuity boundary in the projection-based frame IMG, the pixel value of the spatial neighbor BK_{N} is not misused by the intra prediction circuit 223, thereby improving the coding efficiency.

Further, the control circuit 202 may seta syntax element (e.g., a flag) to indicate whether or not a spatial neighbor is treated as non-available when a current block and the spatial neighbor are located at different projection faces and are on opposite sides of one of said least one image content discontinuity boundary, where the syntax element (e.g., flag) is transmitted to a video decoder via the bitstream BS.

Moreover, the modified coding tool which treats a spatial neighbor as non-available may be enabled at a decoder-side prediction stage. For example, the inter prediction circuit 312 of the video decoder 300 may employ the modified coding tool. Hence, assuming that the 360 VR projection layout L_VR is set by the aforementioned compact layout 500 shown in FIG. 5, the inter prediction circuit 312 (particularly, the MV calculation circuit 310) performs an inter prediction operation upon the current block BK_{C}. According to the modified coding tool, the inter prediction circuit 312 (particularly, the MV calculation circuit 310) checks if the current block BK_{C} and the spatial neighbor (e.g., BK_{N}) are located at different projection faces in the reconstructed frame IMG_R′ and are on opposite sides of one image content discontinuity boundary in the reconstructed frame IMG_R′. When a checking result indicates that the current block BK_{C} and the spatial neighbor (e.g., BK_{N}) are located at different projection faces in the reconstructed frame IMG_R′ and are on opposite sides of one image content discontinuity boundary in the reconstructed frame IMG_R′, the inter prediction circuit 312 (particularly, the MV calculation circuit 310) treats the spatial neighbor BK_{N} as non-available to the inter prediction operation of the current block BK_{C}. For example, the current block BK_{C} may be a prediction unit (PU), and the spatial neighbor BK_{N} (which is a block that is already reconstructed/decoded by the video decoder 300) may be a spatial candidate included in a candidate list of an AMVP mode, a merge mode, or a skip mode, where the candidate list is constructed at the decoder side.

In addition, a syntax element (e.g., a flag) may be transmitted via the bitstream BS to indicate whether or not a spatial neighbor is treated as non-available when a current block and the spatial neighbor are located at different projection faces and are on opposite sides of one of said least one image content discontinuity boundary. Hence, the syntax element (e.g., flag) is parsed from the bitstream BS by the entropy decoding circuit 302 of the video decoder 300 and then output to the control circuit 330 of the video decoder 300.

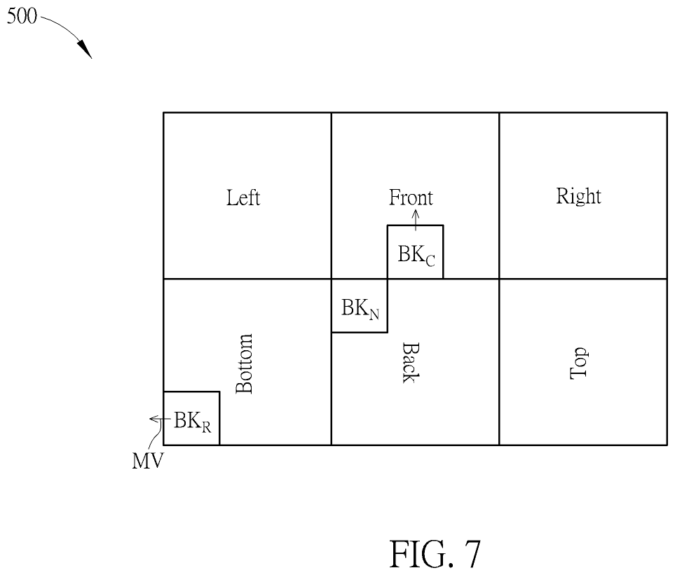

Please refer to FIGS. 4-5 in conjunction with FIG. 7. FIG. 7 is a diagram illustrating a modified coding tool which finds a real neighbor for inter prediction according to an embodiment of the present invention. In some embodiments of the present invention, the modified coding tool of finding a real neighbor may be enabled at an encoder-side inter prediction stage. For example, the inter prediction circuit 220 of the video encoder 200 may employ the modified coding tool. Hence, the inter prediction circuit 220 (particularly, the motion estimation circuit 221) performs an inter prediction operation upon a current block BK_{C}. According to the modified coding tool, the inter prediction circuit 220 (particularly, the motion estimation circuit 221) checks if the current block BK_{C} and a spatial neighbor (e.g., BK_{N}) of the current block BK_{C} are located at different projection faces in the projection-based frame IMG and are on opposite sides of one image content discontinuity boundary in the projection-based frame IMG. When a checking result indicates that the current block BK_{C} and the spatial neighbor (e.g., BK_{N}) are located at different projection faces in the projection-based frame IMG and are on opposite sides of one image content discontinuity boundary in the projection-based frame IMG, the inter prediction circuit 220 (particularly, the motion estimation circuit 221) finds a real neighbor BK_{R} of the current block BK_{C}, and uses the real neighbor BK_{R} to take the place of the spatial neighbor BK_{N} for use in the inter prediction of the current block BK_{C}.

As shown in FIG. 7, the current block BK_{C} is a part of the square projection face “Front”, the spatial neighbor BK_{N} is a part of the square projection face “Back”, and the current block BK_{C} and the spatial neighbor BK_{N} are on opposite sides of the image content discontinuity boundary between side S02 of the square projection face “Front” and side S12 of the square projection face “Back”. Hence, the spatial neighbor BK_{N} is a wrong neighbor of the current block BK_{C} due to image content discontinuity. As can be known from FIG. 4 and FIG. 7, the real neighbor BK_{R} corresponds to a first image content on the sphere 402, and the current block BK_{C} corresponds to a second image content on the sphere 402, where the first image content on the sphere is adjacent to the second image content on the sphere. More specifically, the real neighbor BK_{R} is adjacent to the current block BK_{C} in the 3D space. Hence, an image content at the upper-left corner of the real neighbor BK_{R} shown in FIG. 7 and the image content at the bottom-left corner of the current neighbor BK_{C} shown in FIG. 7 have image content continuity.

Since the spatial neighbor BK_{N} is a wrong neighbor of the current block BK_{C}, the inter prediction circuit 220 (particularly, the motion estimation circuit 221) avoids using the wrong neighbor for inter prediction, and uses the real neighbor BK_{R} (which is a block that is already reconstructed/encoded by the video encoder 200) for inter prediction. For example, the current block BK_{C} is a prediction unit (PU), and the spatial neighbor BK_{N} (which is a block that is already reconstructed by the video encoder 200) is a spatial candidate included in a candidate list of an AMVP mode, a merge mode, or a skip mode, where the candidate list is constructed at the encoder side. The real neighbor BK_{R} found by the inter prediction circuit 220 (particularly, the motion estimation circuit 221) takes the place of the spatial neighbor BK_{N}, such that the motion information of the real neighbor BK_{R} is used by the inter prediction circuit 220 (particularly, the motion estimation circuit 221) for coding efficiency improvement.

In this example, the motion vector MV of the real neighbor BK_{R} points leftwards. However, the square projection face “Bottom” is rotated and then packed in the compact projection format 500 with the 2×3 packing format. The inter prediction circuit 220 (particularly, the motion estimation circuit 221) further applies appropriate rotation to the motion vector MV of the real neighbor BK_{R} when the motion vector MV of the real neighbor BK_{R} is used as a predictor of the current block BK_{C}. As shown in FIG. 7, the predictor assigned to the current block BK_{C} points upwards after the motion vector MV of the real neighbor BK_{R} is rotated properly. In other words, when a motion vector of a real neighbor is used as a predictor of a current block, a direction of the predictor assigned to the current block is not necessarily same as a direction of the motion vector of the real neighbor. For example, the direction of the motion vector of the real neighbor may be rotated according to the actual 3D location relationship between the real neighbor and the current neighbor.

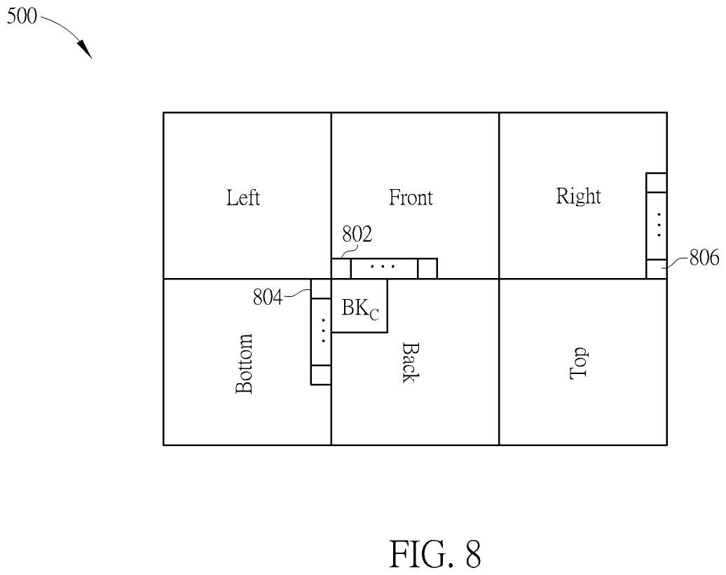

Please refer to FIGS. 4-5 in conjunction with FIG. 8. FIG. 8 is a diagram illustrating a modified coding tool which finds a real neighbor for intra prediction according to an embodiment of the present invention. In some embodiments of the present invention, the modified coding tool of finding a real neighbor may be enabled at an encoder-side intra prediction stage. For example, the intra prediction circuit 223 of the video encoder 200 may employ the modified coding tool. Hence, the intra prediction circuit 223 performs an intra prediction operation upon a current block BK_{C}. According to the modified coding tool, the intra prediction circuit 223 checks if the current block BK_{C} (e.g., one prediction unit (PU)) and a spatial neighbor (e.g., one reference sample 802) of the current block BK_{C} are located at different projection faces in the projection-based frame IMG and are on opposite sides of one image content discontinuity boundary in the projection-based frame IMG. When a checking result indicates that the current block BK_{C} and the spatial neighbor (e.g., one reference sample 802) are located at different projection faces in the projection-based frame IMG and are on opposite sides of one image content discontinuity boundary in the projection-based frame IMG, the intra prediction circuit 223 finds a real neighbor 806 (which is a pixel that is already reconstructed/encoded by the video encoder 200) of the current block BK_{C} in the projection-based frame IMG, and uses the real neighbor 806 to take the place of the spatial neighbor (e.g., one reference sample 802) for use in the intra prediction of the current block BK_{C}.

The reference samples 804 above the current block BK_{C} and the reference samples 804 to the left of the current block BK_{C} may be used to select an intra prediction mode (IPM) for the current block BK_{C}. Specifically, an intra-mode predictor of the current block BK_{C} includes the reference samples 802 and 804. As shown in FIG. 8, the current block BK_{C} is a part of the square projection face “Back”, spatial neighbors above the current block BK_{C} (e.g., reference samples 802) are parts of the square projection face “Front”, and spatial neighbors to the left of the current block BK_{C} (e.g., reference samples 804) are parts of the square projection face “Bottom”. Since the current block BK_{C} and each spatial neighbor above the current block BK_{C} (e.g., reference sample 802) are on opposite sides of the image content discontinuity boundary between side S02 of the square projection face “Front” and side S12 of the square projection face “Back”, each spatial neighbor above the current block BK_{C} is a wrong neighbor of the current block BK_{C} due to image content discontinuity. As can be known from FIG. 4 and FIG. 8, each of the real neighbors 806 corresponds to a first image content on the sphere 402, and the current block BK_{C} corresponds to a second image content on the sphere 402, where the first image content on the sphere is adjacent to the second image content on the sphere. More specifically, each of the real neighbors 806 is adjacent to the current block BK_{C} in the 3D space.

Since the spatial neighbors above the current block BK_{C} (e.g., reference samples 802) are wrong neighbors of the current block BK_{C}, the intra prediction circuit 223 avoids using any of the wrong neighbors for intra prediction, and uses the real neighbors 806 for intra prediction. In other words, the real neighbors 806 found by the intra prediction circuit 223 takes the place of the spatial neighbors above the current block BK_{C} (e.g., reference samples 802), such that the pixel values of the real neighbors 806 are used by the intra prediction circuit 223 for coding efficiency improvement.

In the example shown in FIG. 8, the spatial neighbors (i.e., reference samples 802 and 804) are used to serve as an intra-mode predictor of the current block BK_{C}. The intra-mode predictor of the current block BK_{C} shown in FIG. 8 is an L-shape structure. However, this is for illustrative purposes only, and is not meant to be a limitation of the present invention. In other embodiments of the present invention, the intra-mode predictor is not necessarily an L-shape structure. For certain projection formats, the intra-mode predictor may be a non-L-shape structure.

The intra prediction mode (IPM) of a current block (e.g., a current PU) may be either signaled explicitly or inferred from prediction modes of spatial neighbors of the current block (e.g., neighboring PUs). The prediction modes of the spatial neighbors are known as most probable modes (MPMs). To create an MPM list, multiple spatial neighbors of the current block should be considered. In some embodiments of the present invention, the modified coding tool of finding a real neighbor may be enabled at an encoder-side inter prediction stage for MPM list construction.

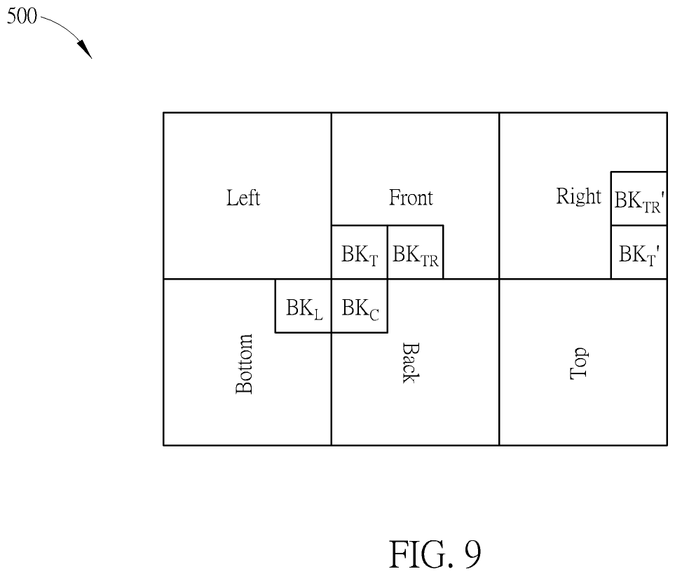

Please refer to FIGS. 4-5 in conjunction with FIG. 9. FIG. 9 is a diagram illustrating a modified coding tool which finds a real neighbor for MPM list construction of intra prediction according to an embodiment of the present invention. For example, the intra prediction circuit 223 of the video encoder 200 may employ the modified coding tool. Hence, the intra prediction circuit 223 performs an intra prediction operation upon a current block BK_{C}. According to the modified coding tool, the intra prediction circuit 223 checks if the current block BK_{C} (e.g., a prediction unit (PU)) and a spatial neighbor (e.g., one neighboring PU that is already reconstructed/encoded by the video encoder 200) of the current block BK_{C} are located at different projection faces in the projection-based frame IMG and are on opposite sides of one image content discontinuity boundary in the projection-based frame IMG. When a checking result indicates that the current block BK_{C} and the spatial neighbor are located at different projection faces in the projection-based frame IMG and are on opposite sides of one image content discontinuity boundary in the projection-based frame IMG, the intra prediction circuit 223 finds a real neighbor (which is a PU that is already reconstructed/encoded by the video encoder 200) of the current block BK_{C}, and uses the real neighbor to take the place of the spatial neighbor for use in the intra prediction of the current block BK_{C}.

As shown in FIG. 9, the current block BK_{C} is a part of the square projection face “Back”, spatial neighbors BK_{T} and BK_{TR} are parts of the square projection face “Front”, and the spatial neighbor BK_{L} is a part of the square projection face “Bottom”. Since the current block BK_{C} and the spatial neighbor BK_{T}/BK_{TR} are on opposite sides of the image content discontinuity boundary between side S02 of the square projection face “Front” and side S12 of the square projection face “Back”, each of the spatial neighbors BK_{T} and BK_{TR} is a wrong neighbor of the current block BK_{C} due to image content discontinuity. As can be known from FIG. 4 and FIG. 9, the real neighbor BK_{T}′/BK_{TR}′ corresponds to a first image content on the sphere 402, and the current block BK_{C} corresponds to a second image content on the sphere 402, where the first image content on the sphere is adjacent to the second image content on the sphere. More specifically, each of the real neighbors B_{KT}′ and BK_{TR}′ is adjacent to the current block BK_{C} in the 3D space.

Since the spatial neighbors BK_{T} and BK_{TR} are wrong neighbors of the current block BK_{C}, the intra prediction circuit 223 avoids using any of the wrong neighbors for MPM list construction in the intra prediction mode, and uses the real neighbors BK_{T} and BK_{TR}′ for MPM list construction in the intra prediction mode. Specifically, the real neighbor BK_{T}′ found by the intra prediction circuit 223 takes the place of the spatial neighbor BK_{T} and the real neighbor BK_{TR}′ found by the intra prediction circuit 223 takes the place of the spatial neighbor BK_{TR}, such that modes of the real neighbors BK_{T} and BK_{TR}′ are used by MPM list construction for coding efficiency improvement.

Moreover, the modified coding tool of finding a real neighbor may be enabled at a decoder-side prediction stage. For example, the inter prediction circuit 312 of the video decoder 300 may employ the modified coding tool. For another example, the intra prediction circuit 314 of the video decoder 300 may employ the modified coding tool. Hence, assuming that the 360 VR projection layout L_VR is set by the compact layout 500 shown in FIG. 5, a prediction circuit (e.g., inter prediction circuit 312 or intra prediction circuit 314) performs a prediction operation (e.g., an inter prediction operation or an intra prediction operation) upon a current block BK_{C}. According to the modified coding tool, the prediction circuit checks if the current block BK_{C} and a spatial neighbor (e.g., BK_{N} in FIG. 7, or 802 in FIG. 8, or BK_{T}/BK_{TR} in FIG. 9) are located at different projection faces in the reconstructed frame IMG_R′ and are on opposite sides of one image content discontinuity boundary in the reconstructed frame IMG_R′. When a checking result indicates that the current block BK_{C} and the spatial neighbor are located at different projection faces in the reconstructed frame IMG_R′ and are on opposite sides of one image content discontinuity boundary in the reconstructed frame IMG_R′, the prediction circuit finds a real neighbor (e.g., BK_{R} in FIG. 7, or 806 in FIG. 8, or BK_{T}′/BK_{TR}′ in FIG. 9), and uses the real neighbor to take the place of the spatial neighbor for use in the prediction operation of the current block BK_{C}. In a case where the prediction operation is the inter prediction operation, the current block BK_{C} may be a prediction unit (PU), and the spatial neighbor BK_{N} may be a spatial candidate included in a candidate list of an AMVP mode, a merge mode, or a skip mode. It should be noted that the motion vector of the real neighbor should be appropriately rotated when the motion vector of the real neighbor is used by inter prediction of the current block. In another case where the prediction operation is the intra prediction operation, the current block BK_{C} may be a prediction unit (PU), and the spatial neighbor BK_{N} may be a reference sample (which is used by the signaled intra prediction mode) or a neighboring PU (which is needed for constructing an MPM list at the decoder side).

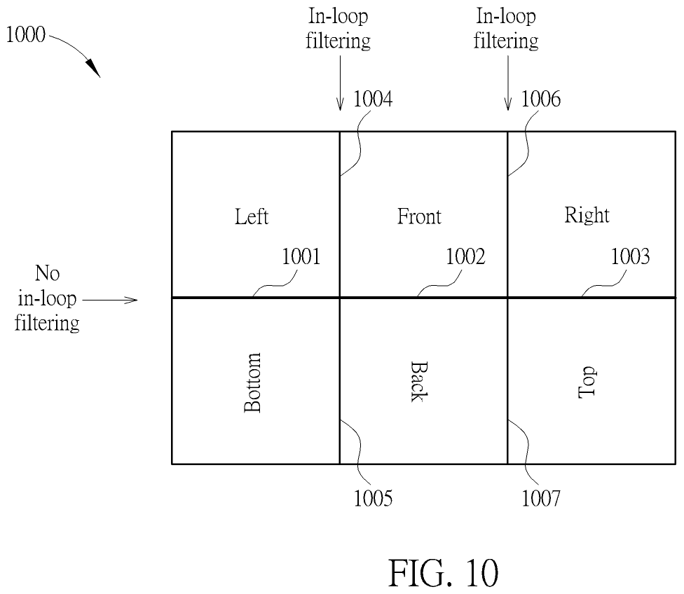

Please refer to FIG. 5 in conjunction with FIG. 10. FIG. 10 is a diagram illustrating a modified coding tool which prevents in-loop filtering from being applied to discontinuous face edges in a reconstructed frame with a first projection layout according to an embodiment of the present invention. In some embodiments of the present invention, the modified coding tool of preventing in-loop filtering from being applied to discontinuous face edges may be enabled at an encoder-side in-loop filtering stage. For example, the in-loop filter 218 of the video encoder 200 may employ the modified coding tool. Hence, the reconstruction circuit 217 generates a reconstructed frame IMG_R during encoding of the projection-based frame IMG, and the in-loop filter 218 applies an in-loop filtering operation to the reconstructed frame IMG_R, where the in-loop filtering operation is blocked from being applied to each image content discontinuity boundary (i.e., each discontinuous face edge) in the reconstructed frame IMG_R. As mentioned above, the reconstructed frame IMG_R also has a 360-degree image content represented by projection faces arranged in the same 360 VR projection layout L_VR. Supposing that the 360 VR projection layout L_VR is set by the compact layout 500 with the 3×2 padding format, the reconstructed frame IMG_R has a projection layout 1000 that is same as the compact layout 500 shown in FIG. 5. Hence, an image content discontinuity boundary 1001 exists between the reconstructed projection faces “Left” and “Bottom”, an image content discontinuity boundary 1002 exists between the reconstructed projection faces “Front” and “Back”, an image content discontinuity boundary 1003 exists between the reconstructed projection faces “Right” and “Top”, an image content continuity boundary 1004 exists between the reconstructed projection faces “Left” and “Front”, an image content continuity boundary 1005 exists between the reconstructed projection faces “Bottom” and “Back”, an image content continuity boundary 1006 exists between the reconstructed projection faces “Front” and “Right”, and an image content continuity boundary 1007 exists between the reconstructed projection faces “Back” and “Top”. The in-loop filter (e.g., de-blocking filter, SAO filter, or ALF) 218 is allowed to apply in-loop filtering to the image content continuity boundaries 1004, 1005, 1006, and 1007 that are continuous face edges, but is blocked from applying in-loop filtering to the image content discontinuity boundaries 1001, 1002, and 1003 that are discontinuous face edges. In this way, the image quality of the reconstructed frame IMG_R is not degraded by applying in-loop filtering to discontinuous face edges.

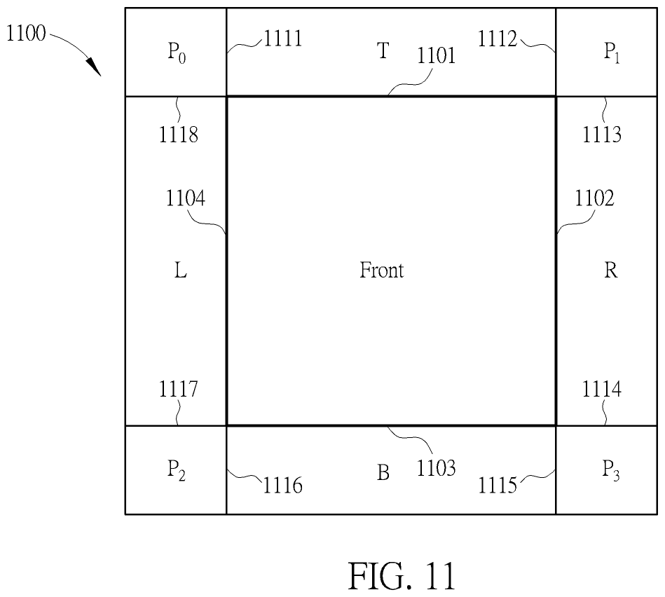

It should be noted that the same adaptive in-loop filtering scheme may be applied to a reconstructed frame with a different projection layout. FIG. 11 is a diagram illustrating a modified coding tool which applies in-loop filtering to continuous face edges in a reconstructed frame with a second projection layout according to an embodiment of the present invention. In this example, the 360 VR projection layout L_VR is set by a compact layout with a face-based padding format, such that the reconstructed frame IMG_R has a projection layout 1100 shown in FIG. 11. In accordance with the compact layout with the face-based padding format, the reconstructed projection face “Front” shown in FIG. 11 corresponds to the projection face “Front” shown in FIG. 4, the reconstructed projection face “T” shown in FIG. 11 corresponds to a part of the projection face “Top” shown in FIG. 4, the reconstructed projection face “L” shown in FIG. 11 corresponds to a part of the projection face “Left” shown in FIG. 4, the reconstructed projection face “B” shown in FIG. 11 corresponds to a part of the projection face “Bottom” shown in FIG. 4, the reconstructed projection face “R” shown in FIG. 11 corresponds to a part of the projection face “Right” shown in FIG. 4, and four reconstructed dummy areas P₀, P₁, P₂, and P₃ (e.g., black areas or white areas) are located at four corners.

In this example, an image content boundary 1111 exists between the reconstructed projection face “T” and the reconstructed dummy area P₀, an image content boundary 1112 exists between the reconstructed projection face “T” and the reconstructed dummy area P₁, an image content boundary 1113 exists between the reconstructed projection face “R” and the reconstructed dummy area P₁, an image content boundary 1114 exists between the reconstructed projection face “R” and the reconstructed dummy area P₃, an image content boundary 1115 exists between the reconstructed projection face “B” and the reconstructed dummy area P₃, an image content boundary 1116 exists between the reconstructed projection face “B” and the reconstructed dummy area P₂, an image content boundary 1117 exists between the reconstructed projection face “L” and the reconstructed dummy area P₂, and an image content boundary 1118 exists between the reconstructed projection face “L” and the reconstructed dummy area P₀. The image content boundaries 1111-1118 may be image content continuity boundaries (i.e., continuous face edges) or image content discontinuity boundaries (i.e., discontinuous face edges), depending on the actual pixel padding designs of the dummy areas P₀, P₁, P₂, and P₃ located at the four corners. In addition, an image content continuity boundary 1101 exists between the reconstructed projection faces “Front” and “T”, an image content continuity boundary 1102 exists between the reconstructed projection faces “Front” and “R”, an image content continuity boundary 1103 exists between the reconstructed projection faces “Front” and “B”, and an image content continuity boundary 1104 exists between the reconstructed projection faces “Front” and “L”.

The in-loop filter (e.g., de-blocking filter, SAO filter, or ALF) 218 is allowed to apply in-loop filtering to the image content continuity boundaries 1101-1104 that are continuous face edges, and in-loop filter 218 may be or may not be blocked from applying in-loop filtering to the image content boundaries 1111-1118 depending on whether the face edges are discontinuous face edges or not. In a case where the image content boundaries 1111-1118 are image content continuity boundaries (i.e., continuous face edges), the in-loop filter 218 is allowed to apply in-loop filtering to the image content boundaries 1111-1118. In another case where the image content boundaries 1111-1118 are image content discontinuity boundaries (i.e., discontinuous face edges), the in-loop filter 218 is blocked from applying in-loop filtering to the image content boundaries 1111-1118. In this way, the image quality of the reconstructed frame IMG_R is not degraded by applying in-loop filtering to discontinuous face edges.

Moreover, the modified coding tool of preventing in-loop filtering from being applied to discontinuous face edges and allowing in-loop filtering to be applied to continuous face edges may be enabled at a decoder-side in-loop filtering stage. For example, the in-loop filter 318 of the video decoder 300 may employ the modified coding tool. Hence, the reconstruction circuit 308 generates a reconstructed frame IMG_R′, and the in-loop filter 318 applies an in-loop filtering operation to the reconstructed frame IMG_R′, where the in-loop filtering operation is blocked from being applied to each image content discontinuity boundary (i.e., each discontinuous face edge) in the reconstructed frame IMG_R′, and is allowed to be applied to each image content continuity boundary (i.e., each continuous face edge) in the reconstructed frame IMG_R′.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video processing method comprising:
receiving a bitstream, wherein a part of the bitstream transmits encoded information of a projection-based frame, the projection-based frame has a 360-degree content represented by projection faces packed in a 360-degree Virtual Reality (360 VR) projection layout, and the projection-based frame has at least one boundary; and
decoding, by a video decoder, the part of the bitstream, comprising:
generating a reconstructed frame;
parsing a flag from the bitstream, wherein the flag indicates that an in-loop filtering operation is blocked from being applied to each of said at least one boundary in the reconstructed frame; and
applying the in-loop filtering operation to the reconstructed frame, wherein in response to the flag, the in-loop filtering operation is blocked from being applied to each of said at least one boundary in the reconstructed frame.

2. The video processing method of claim 1, wherein said at least one boundary comprises an image content discontinuity boundary; an omnidirectional content of a sphere is mapped onto the projection faces of a three-dimensional object; regarding the three-dimensional object, one side of a first image area does not connect with one side of a second image area; and regarding the 360 VR projection layout, said one side of the first image area connects with said one side of the second image area, and the image content discontinuity boundary is between said one side of the first image area and said one side of the second image area.

3. The video processing method of claim 2, wherein the first image area is one of the projection faces of the three-dimensional object, and the second image area is another of the projection faces of the three-dimensional object.

4. The video processing method of claim 3, wherein the reconstructed frame further includes at least one image content continuity boundary; the projection faces comprise a first projection face and a second projection face; regarding the three-dimensional object, one side of the first projection face connects with one side of the second projection face; regarding the 360 VR projection layout, said one side of the first projection face connects with said one side of the second projection face, and one of said at least one image content continuity boundary is between said one side of the first projection face and said one side of the second projection face; and the in-loop filtering operation is allowed to be applied to each of said at least one image content continuity boundary.

5. A video processing apparatus comprising:
a video decoder, comprising:
a decoding circuit, arranged to receive a bitstream, parse a flag from the bitstream, decode a part of the bitstream to generate a reconstructed frame, and apply an in-loop filtering operation to the reconstructed frame, wherein the part of the bitstream transmits encoded information of a projection-based frame, the projection-based frame has a 360-degree content represented by projection faces packed in a 360-degree Virtual Reality (360 VR) projection layout, the projection-based frame has at least one boundary, and the flag indicates that the in-loop filtering operation is blocked from being applied to each of said at least one boundary in the reconstructed frame; and
a control circuit, arranged to control the in-loop filtering operation according to the flag, wherein in response to the flag, the in-loop filtering operation is blocked from being applied to each of said at least one boundary in the reconstructed frame.

6. The video processing apparatus of claim 5, wherein said at least one boundary comprises an image content discontinuity boundary; an omnidirectional content of a sphere is mapped onto the projection faces of a three-dimensional object; regarding the three-dimensional object, one side of a first image area does not connect with one side of a second image area; and regarding the 360 VR projection layout, said one side of the first image area connects with said one side of the second image area, and the image content discontinuity boundary is between said one side of the first image area and said one side of the second image area.

7. The video processing apparatus of claim 6, wherein the first image area is one of the projection faces of the three-dimensional object, and the second image area is another of the projection faces of the three-dimensional object.

8. The video processing apparatus of claim 7, wherein the reconstructed frame further includes at least one image content continuity boundary; the projection faces comprise a first projection face and a second projection face; regarding the three-dimensional object, one side of the first projection face connects with one side of the second projection face; regarding the 360 VR projection layout, said one side of the first projection face connects with said one side of the second projection face, and one of said at least one image content continuity boundary is between said one side of the first projection face and said one side of the second projection face; and the in-loop filtering operation is allowed to be applied to each of said at least one image content continuity boundary.
